(19) United States
(12) Patent Application Publication
(10) Pub. No.: US 2019/0122133 A1
(43) Pub. Date: Apr. 25, 2019

(54) QUBIT COUPLING

(71) Applicant: Oxford University Innovation Limited, Oxford (GB)

(72) Inventors: Stefan Zohren, Oxford (GB); Nicholas Chancellor, Oxford (GB); Paul Warburton, Oxford (GB)

(21) Appl. No.: 16/086,585

(22) PCT Filed: Mar. 16, 2017
(86) PCT No.: PCT/GB2017/050717

§ 371 Date: Sep. 19, 2018

(30) Foreign Application Priority Data
Mar. 23, 2016 (GB) 1604954.6

(51) Int. Cl. G06N 10/00

(52) U.S. Cl. CPC G06N 10/00

(57) ABSTRACT

A method of forming coupling interactions between three or more information qubits (3) in a qubit ensemble (5), the method including: coupling the information qubits (3) to each other; coupling each of the information qubits (3) to each of one or more ancilla qubits (9); and controlling the interaction between the information qubits (3) by applying a bias to the one or more ancilla qubits (9), such that the low energy states of the qubit ensemble (5) include three-or-more-body coupling effects between information qubits (3).

The present invention relates to a method of forming coupling interactions between qubits in a quantum annealer, and a quantum annealer including coupling interactions between three or more qubits.

Quantum computers make use of the fundamental laws of quantum mechanics to provide significantly enhanced processing power compared to classical computers. A quantum annealer is a type of computer than is used to solve certain types of problems, such as optimisation problems.

A complex optimisation problem is often described in terms of a cost function, that must be minimised to find a minimum cost. The cost function may involve a number of variables, and the variables may be grouped into a number of terms. Each variable may appear in multiple terms, and each term may have any number of variables.

A quantum annealer includes an ensemble of qubits. Each qubit corresponds to a variable in the cost function. The energy landscape of the ensemble of qubits is complex, having many local minima and maxima. Quantum tunnelling is used to enable the ensemble to move to the lowest energy state (the ground state), which corresponds to the lowest cost solution of the optimisation problem. The state of each of the qubits in the ground state provides the value of the variables in the solution to the optimisation problem.

For every term of the cost function, each qubit corresponding to a variable in that term should be coupled to the other qubits corresponding to the other variables in the same term. However, in existing quantum computer, such as the D-wave two ® from D-Wave Systems Inc., qubits can only couple in pairs (also referred to as 2-local coupling), meaning cost functions having terms with three or more variables cannot be solved directly.

Typically, this is overcome by defining the problem in such a way that it only includes terms having one or two variables. However, this increases the complexity of the problem, requires more qubits and is costly in time and resources.

According to a first aspect of the invention, there is provided a method of forming coupling interactions between three or more information qubits in a qubit ensemble, the method including: coupling the information qubits to each other; coupling each of the information qubits to each of one or more ancilla qubits; and controlling the interaction between the information qubits by applying a bias to the one or more ancilla qubits, such that the low energy states of the qubit ensemble include three-or-more-body coupling effects between information qubits.

The method enables a qubit ensemble in a quantum annealer to form an energy landscape that is equivalent to having coupling between 3 or more qubits (N-local coupling). This means that the quantum annealer can be used to solve complex optimisation problems, involving terms having many variables, without having to modify the problem so each term only has a pair of variables. This also means that the low energy states other than the ground state can be obtained, providing a spectrum of the outcome, rather than a single solution.

Biasing the ancilla qubits to control the coupling between the information qubits may modify the energy spectrum of the ensemble of information qubits by adding a penalty energy dependent on the state of the information qubits.

Each qubit may have two states, and the energy penalty may be a symmetric penalty, such that it is dependent on the number of qubits in each state.

The method may be for forming coupling interactions between three information qubits. The method may include coupling the three information qubits to a single ancilla qubit.

The strength of the coupling between the ancilla qubit and the information qubits may be greater than the strength of the coupling between information qubits.

Coupling each of the information qubits to each of one or more ancilla qubits may include: coupling the information qubits to an equal number of ancilla qubits.

Each ancilla qubit may only be coupled to information qubits.

Coupling the information qubits to an equal number of ancilla qubits may include: coupling the ancilla qubits to each other and to the information qubits; and offsetting the coupling between the ancilla qubits.

The ancilla qubits may be arranged such that when an information qubit flips state, a predetermined ancilla qubit flips states, the predetermined ancilla qubit based on the total number of qubits in each state before and after the information qubit is flips state.

Applying a bias to the one or more ancilla qubits may include: applying a different bias to each ancilla qubit, such that ancilla qubits are ordered based on the applied bias.

Controlling the interaction between the information qubits may also include one or more of: setting the strength of the coupling between the information qubits; setting the strength of the coupling between the information qubits and the ancilla qubits; and applying a uniform bias to the information qubits.

The method may include: forming a first interaction between a first set of information qubits of the qubit ensemble by: coupling the first set of information qubits to each other; coupling each of the first set of information qubits to each of one or more ancilla qubits of a first set of ancilla qubits; and controlling the interaction between the first set of information qubits by applying a bias to the first set of ancilla qubits; and forming a second interaction between a second set of information qubits of the qubit ensemble by: coupling the second set of information qubits to each other; coupling each of the second set of information qubits to each of one or more ancilla qubits of a second set of ancilla qubits; and controlling the interaction between the second set of information qubits by applying a bias to the second set of ancilla qubits.

The first set of information qubits and the second set of information qubits may share one or more qubits. The first set of ancilla qubits and the second set of ancilla qubits may be separate.

The method may include programming an optimisation problem into a quantum annealer including the qubit ensemble by applying biases to the information qubits and the ancilla qubits, and setting the strength of the coupling between the information qubits, and the strength of the coupling between the information qubits and the ancilla qubits, wherein the biases and coupling strengths are derived from the optimisation problem, such that interactions are formed between sets of qubits corresponding to terms of the optimisation problem.

The method may include running a quantum annealing process on the quantum annealer, in order to obtain the state of the qubits in one or more low energy states, the states of the qubits corresponding to solution of the optimisation problem.

According to a second aspect of the invention, there is provided a quantum annealer including: an ensemble of three or more information qubits; one or more ancilla qubits; means for coupling the information qubits to each other; means for coupling each of the information qubits to each of the one or more ancilla qubits; and means for applying a bias to the one or more ancilla qubits to control the coupling between the information qubits, such that the low energy states of the qubit ensemble include three-or-more-body coupling effects between the information qubits.

The quantum annealer provides a simple and efficient way to implement the method of the first aspect. The information qubits of the quantum annealer have an energy landscape that is equivalent to having coupling between 3 or more qubits (N-local coupling), and can be used to solve complex optimisation problems, involving terms having many variables, without having to modify the problem so each term only has a pair of variables. This also means that the low energy states other than the ground state can be obtained.

Applying a bias to the ancilla qubits to control the coupling between the information qubits may modify the energy spectrum of the ensemble of information qubits by adding a penalty energy dependent on the state of the information qubits.

Each qubit may have two states, and the energy penalty may be a symmetric penalty, such that it is dependent on the number of qubits in each state.

The quantum annealer may include a first coupling loop, and the means for coupling the information qubits to each other may comprise means for inductively coupling each information qubit to the coupling loop, with equal strength.

The means for coupling each of the information qubits to each of the one or more ancilla qubits may comprise means for inductively coupling the or each ancilla qubit to the first coupling loop, with equal strength.

Three information qubits may be coupled to a single ancilla qubit.

The coupling of the ancilla qubit to the information qubits may be twice as strong as the coupling of the information qubits to each other.

The quantum annealer may include an additional coupling loop. Only the information qubits may be coupled to the additional coupling loop. The additional coupling loop may be for setting the strength of the coupling between the information qubits.

The information qubits may be coupled to an equal number of ancilla qubits.

Each ancilla qubit may only be coupled to information qubits. The coupling between the ancilla qubits and the information qubits may be the same strength as the coupling between information qubits.

The first coupling loop may provide coupling interactions between the ancilla qubits. The quantum annealer may include means for offsetting the coupling between the ancilla qubits.

The means for offsetting the coupling between the ancilla qubits may include an offset loop, and means for inductively coupling the ancilla qubits to the offset loop.

The means for applying a bias to the one or more ancilla qubits may include means for applying separate, different, bias to each ancilla qubit, such that ancilla qubits are ordered based on the applied bias.

The quantum annular may include means for setting one or more of: the strength of the couplings between the information qubits; the strength of the couplings between the information qubits and the ancilla qubits; and a uniform bias to the information qubits.

The means for setting the strength of the couplings may comprise means for applying a bias the coupling loop and/or the offset loop.

The quantum annealer may include a first set of ancilla qubits, for forming a first interaction between a first set of information qubits of the qubit ensemble; and a second set of ancilla qubits, for forming a second interaction between a second set of information qubits of the qubit ensemble.

The first set of information qubits and the second set of information qubits may share one or more qubits. The first set of ancilla qubits and the second set of ancilla qubits may be separate.

The biases and coupling strengths may be derived from an optimisation problem. The interaction between the information qubits may be controlled based on the relationships between variables in terms of the optimisation problem, at least some terms including three of more variables.

The quantum annular may include means for applying an annealing field to the quantum annealer, and means for reducing the annealing field to run an annealing process.

The information qubits and ancilla qubits may be superconducting flux qubits. Applying a bias to the qubit may comprise applying a magnetic field. The first coupling loop may be a loop formed by a superconducting wire or transmission line. The offset loop may be formed by a superconducting wire or transmission line.

It will be appreciated that features described in relation to any of the above aspects may also be applied to the other aspects.

Embodiments of the invention will now be described, by way of example only, with reference to the accompanying drawings, in which:

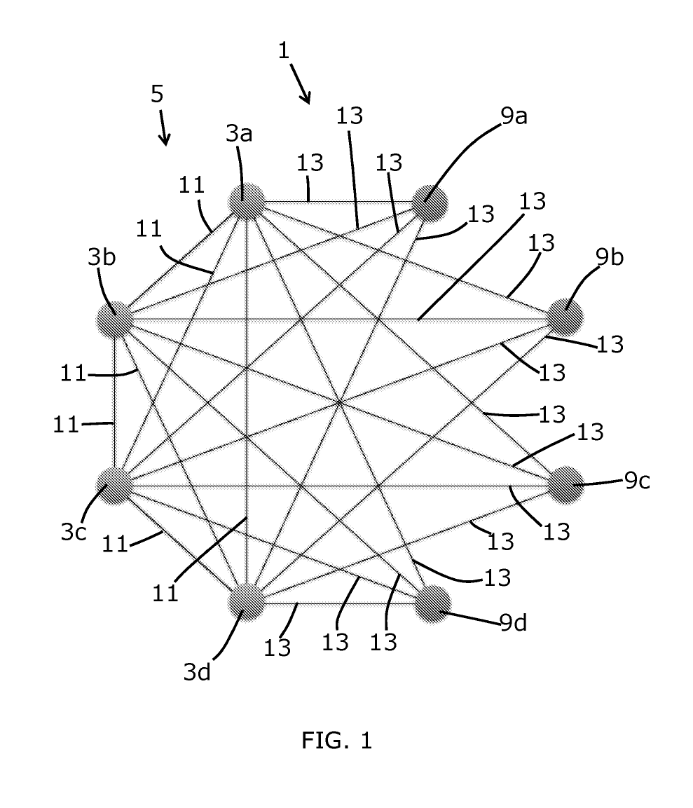

FIG. 1 schematically illustrates the coupling between information and ancilla qubits in a 4-local coupler, according to one embodiment of the invention;

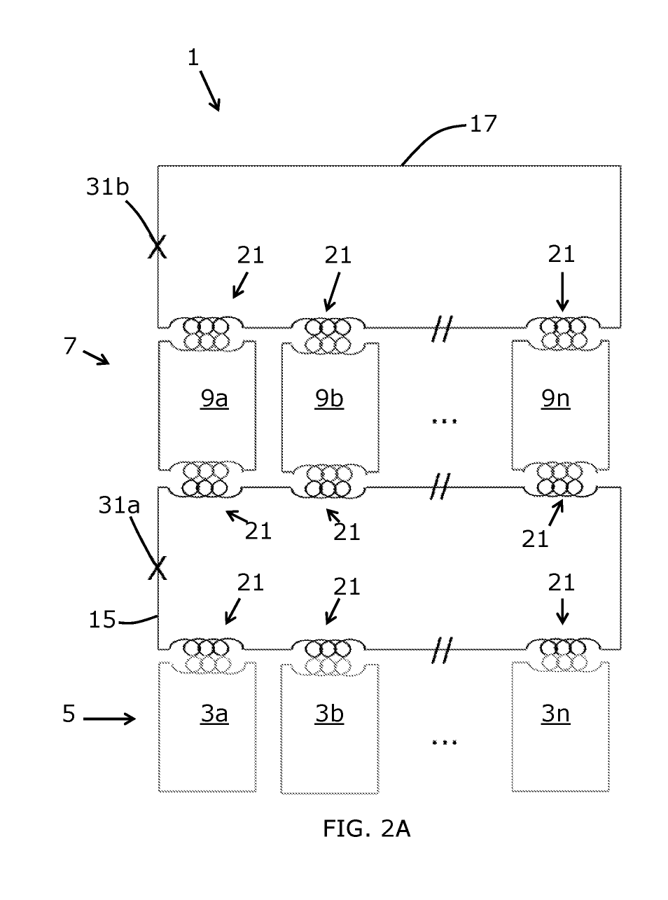

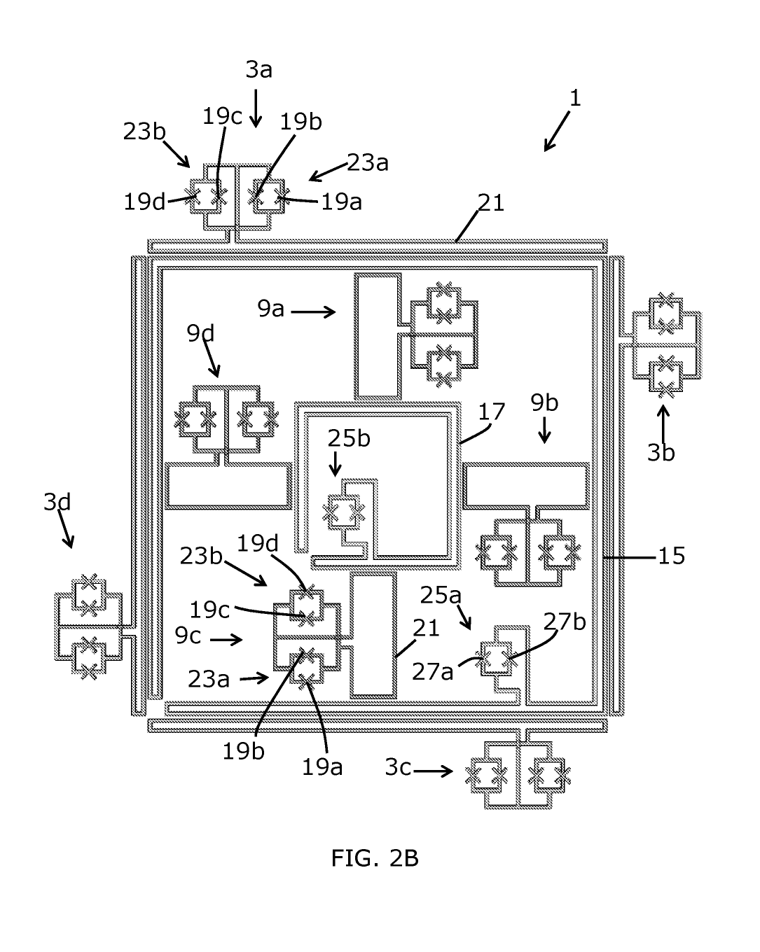

FIG. 2A schematically illustrates a circuit for implemented the connectivity illustrated in FIG. 1, in a coupler connected to any number of qubits;

FIG. 2B illustrates an example implementation of the circuit of FIG. 2 with four qubits;

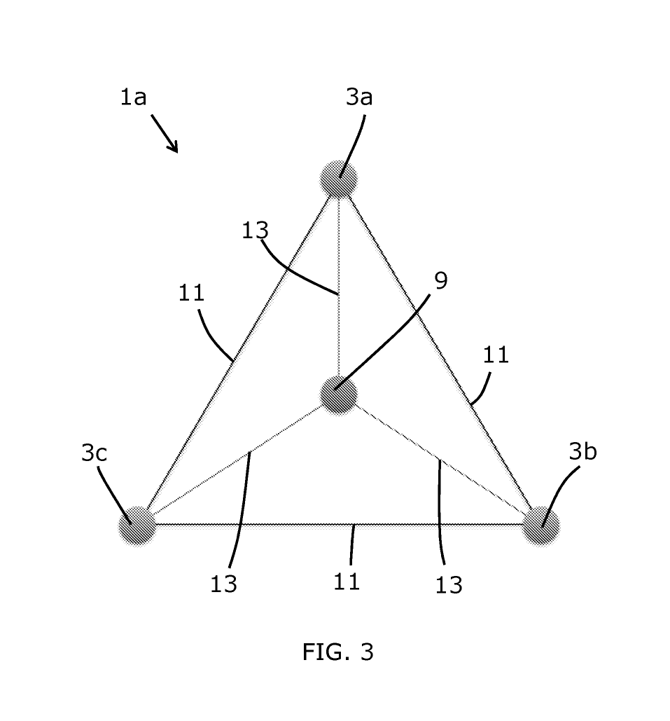

FIG. 3 schematically illustrates the coupling in a 3-local coupler, according to another embodiment of the invention; and

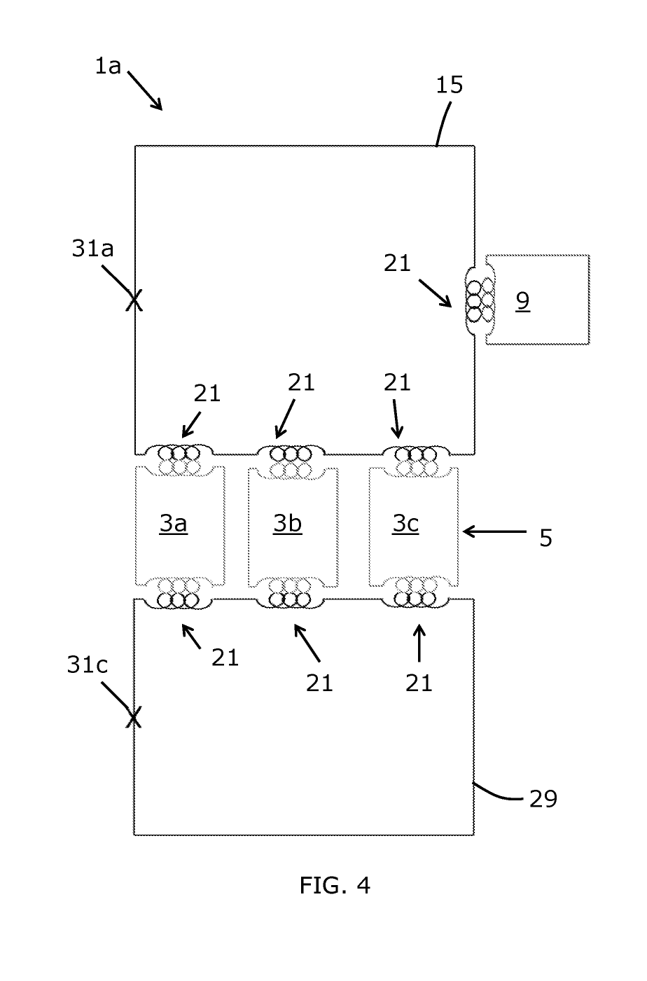

FIG. 4 schematically illustrates a circuit for forming the coupler shown in FIG. 3.

FIGS. 1 and 2 shows an example of a system (a quantum annealer) 1 including a coupler 7 for providing 4-local coupling between four information qubits 3 in a qubit ensemble 5. The qubit ensemble 5 may have more qubits 3, which are not shown for clarity. FIG. 1 shows the coupling interactions 11, 13 in the system 1.

The coupler 7 includes four ancilla qubits 9. The coupling interactions 11, 13 are 2-local interactions that couple pairs of qubits 3, 9 together. First coupling interactions 11 are formed between each of the information qubits 3. Second coupling interactions 13 are formed between each information qubit 3 and each of the four ancilla qubits 9. The ancilla qubits 9 do not provide information about the solution of the problem.

The quantum annealer 1 can be used to solve an optimisation problem, which is described in terms of a cost function that is to be minimised. The optimisation problem uses the information qubits 3 to encode the variables of the cost function of the optimisation problem as Ising spin models. The energy landscape of the ensemble 5 is controlled by varying the magnetic fields applied to the information qubits 3, ancilla qubits 9, and the strength of the couplings 11, 13. The fields and coupling strengths control the energy contribution of each information qubit 3 to the energy landscape, so that each information qubit 9 corresponds to a variable in the cost function, and qubits interact in the same way as the variables in the cost function.

The ancilla qubits 9 add an additional energy to the energy landscape of the system 1. The additional energy depends on the number of information qubits 3 in each state, and allows the energy landscape of the system 1 to be controlled based on the problem. Since the additional energy is the same for all variations of the ensemble 5 where the same number of information qubits 3 are in a given state, regardless of which specific information qubits 3 are in each state, it can be referred to as a symmetric energy penalty. The coupling interactions 11, 13 and ancilla qubits 9 are controlled by external magnetic fields so that the energy penalty causes the energy landscape of the qubit ensemble 5 to approximate the energy landscape of a 4-local coupler coupled to the information qubits 3. This is achieved using only ancilla qubits 9 and 2-local couplings 11, 13.

Conceptually, this system 1 can be extended to provide a coupler with any number (N) of ancilla qubits 9, which can be used to provide coupling interactions between N information qubits 3. The information qubits 3 are considered to be fully connected to each other and the ancilla qubits 9, while the ancilla qubits 9 are connected to all of the information qubits 3, but not each other.

In a system 1 with N information qubit 3 and N ancilla qubits 9, each ancilla qubit 9 is coupled to all of the information qubits 3 by 2-local interactions with equal strength (Jₐ), and each information qubit 3 is coupled to the other information qubit 3 by 2-local interactions with equal strength (J). When the information qubits 3 are all subjected to a uniform magnetic field (h), and the ancilla qubits 9 are subjected to different magnetic fields (h_{a,i}), the Hamiltonian of this system 1 is:

$${H}_{N}^{( 2 )} = J {\sum }_{i = 1}^{N} {\sum }_{j = 1}^{i - 1} {σ}_{i}^{z} {σ}_{j}^{z} + h {\sum }_{i = 1}^{N} {σ}_{i}^{z} + {J}_{a} {\sum }_{i = 1}^{N} {\sum }_{j = 1}^{N} {σ}_{i}^{z} {σ}_{a , j}^{z} + {\sum }_{i = 1}^{N} {h}_{a , i} {σ}_{a , i}^{z} \qquad ( 1 )$$

σᵢ^{z} and σⱼ^{z} are the spin states of the information qubits 3 and σ_{a,j}^{z} is the spin state of the ancilla qubits 9. For a qubit 3, 9 with two states, σ^{z}=±1. One example of a qubit with two states, is a spin qubit. In the following description, σ^{z}=+1 for spin up, and σ^{z}=−1 for spin down.

The first term of equation 1 represents the interactions between all possible pairs of information qubits 9, while the third term represent the interactions between all pairs of one ancilla qubit 9 and one information qubit 3. These are the biases (fields) on the information qubits 3 and ancilla qubits 9 respectively. The second and fourth terms represent the effect of the magnetic fields on the information qubits 3 and the ancilla qubits 9 respectively.

The first two terms of equation (1), where the first sum is taken for adjacent qubits 9 only (j=i±1), represent the pairwise interactions in a typical quantum annealer 1.

With s information qubits in the spin up state (and hence N-s information qubits 3 in the spin down state) the effective bias on a single ancilla qubit 9a from the ensemble 5 of information qubits 3 is given by:

$${J}_{a} {\sum }_{i = 1}^{N} {σ}_{i}^{z} = {J}_{a} [ ( - 1 ) ( N - s ) + ( + 1 ) ( s ) ] = {J}_{a} ( - N + 2 s ) \qquad ( 2 )$$

When Jₐ is positive and sufficiently large to force the ancilla qubits 9 into the ground state, and a field of h_{a,i}=Jₐ(−2i+N) is applied to the i^{th} ancilla qubit 9, then the effective bias on the i^{th} ancilla qubit 9 is positive for i<s, negative for i>s, and 0 for i=s. This constrains the i^{th} ancilla to be down for i<s and up for i>s, to minimise the energy.

For i=s, the i^{th} qubit is free, and can adopt either spin state. However, an additional bias can introduced to each ancilla qubit 9 through h_{a,i}, by applying a correction to h_{a,i}. The correction is given by:

−Jₐ(2i−N)+qᵢ 0<qᵢ<Jₐ (3)

When the correction is included in h_{a,i}, the i^{th} qubit will be up for i>s, and down for i≤s. The ancilla qubits 9 are ordered based on the field applied to each qubit h_{a,i}. This determines which ancilla qubit 9 is considered the i^{th}.

The correct choice of J, Jₐ, h and h_{a,i} enables the system 1 with the connectivity shown in FIG. 1 (and the Hamiltonian given by equation (1)) to replicate the Hamiltonian of an N-local coupler. Generally, an N-local coupler has a Hamiltonian of the form:

$${H}_{N} = f ( {\sum }_{i = 1}^{N} {σ}_{i}^{z} ) = f ( 2 s - N ) \qquad ( 4 )$$

f is a coupling function based on the number of spins in the up state. It can be used to apply a symmetric energy penalty as required by the problem.

The energy spectrum of a N-local coupler such as described by equation (4) can be replicated by equation (1) by controlling the energy change from flipping a single information qubit 3 in equation (1) to be the same as e energy change from flipping a single information qubit 3 equation (4).

Where s information qubits 9 are in the up configuration, the i^{th} ancilla qubit 9 is up for i>s. Flipping any of the information qubits 9, so that s+1 qubits are up, will change the state of the ancilla qubits 9, so that the i^{th} ancilla qubit is up for i>s+1. The ancilla qubit at i=s will have flipped to down.

The energy from flipping a single information qubit 3 connected to an N-local coupler as described by equation (4) is:

ΔE_{s→s+1}=f′ₛ₊₁ (5)

Where:

$${f}_{i} = f ( 2 i - N ) = {\sum }_{k = 1}^{i} {f}_{k}^{′} - {\sum }_{k = i + 1}^{N} {f}_{k}^{′} \qquad ( 6 )$$

The constraints shown in equations (7a) to (7f) ensure that the energy difference of flipping a qubit state, determined from equation (1) matches the equation difference determined from equation (5).

h_{a,i}=Jₐ(N−2i)+qᵢ (7a)

Jₐ=J>0 (7b)

qᵢ=−1/2f′ᵢ+q₀ (7c)

h=qₒ−J (7b)

q₀>>1/2maxᵢ(f′ᵢ) (7e)

Jₐ>>q₀−maxᵢ(f′ᵢ) (7f)

Therefore, the correct selection of f, based on the problem to be solved, allows q, h, h_{a,i} J and J_{A} to be determined. With correct h, h_{a,i}, J and J_{A}, the system 1 can be used to replicate N-local coupling.

A single flip of one of the information qubits 3 only requires one of the ancilla qubits 9 to flip to return the system 1 to the low energy state, regardless of the number of qubits 3 coupled in this way. In this sense the information qubits 3 are realized as 1st order in perturbation theory regardless of the number of information qubits 3 which are coupled. Since only a single ancilla qubit 9 flips when a single information qubit 3 flips, the system 1 is scalable to support large number of qubits 3 coupled at once, meaning complex terms in optimisation problems can be easily solved.

One example of Hamiltonian of an N-local coupler, is given by H_{N}=f(2s−N)=J_{N}σ₁^{Z} . . . σ_{N}^{Z}. The energy provided by this coupler to the system 1 is +J_{N} if N−s is even, and −J_{N} if N−s is odd. Therefore, for an even number of information qubits in the down state, the energy is +J_{N}, and for an odd number of qubits in the down state, the energy is −J_{N}. Note that one is free to offset H_{N} by a constant energy.

To replicate this coupler, the function f is given by:

$$\begin{matrix}{f}_{s} = f ( 2 s - N ) = \{ \begin{matrix}0 , & N - s ∈ even \\ - 2 {J}_{N} , & N - s ∈ odd\end{matrix} & ( 8 a ) \\ {f}_{s}^{′} = {f}^{′} ( 2 s - N ) = \{ \begin{matrix}2 {J}_{N} , & N - s ∈ even \\ - 2 {J}_{N} , & N - s ∈ odd\end{matrix} & ( 8 b )\end{matrix}$$

This is equal to H_{N}=f (2S N)=J_{N}σ₁^{Z} . . . σ_{N}^{Z} with a constant offset of −J_{N}. The function that provides different energies based on whether the number of information qubits 3 in the down state is odd or even is just one example of a function that can be used to replicate the connectivity shown in FIG. 1. By appropriate choice of the function f, any suitable energy penalty can be created. As further examples, the function f may have a different value for each different number of qubits in the up state, or may have a first value when the number of information qubits 3 in the up state is below a threshold and another value when the number of information qubits 3 in the up state is above the threshold.

In use, the function f is derived from the optimisation problem, in a known manner. The coupling strengths (J, Jₐ) and fields (h, h_{a,i}) are then determined based on equations (7a) to (7f). These parameters are then set by varying the biases applied to the information qubits 3, ancilla qubits 9 and the coupling links 11, 13 between them.

In use, once the optimisation problem is programmed into the system 1, a transverse annealing filed is applied to the system 1. The effect of the transverse annealing field is described by a second Hamiltonian H_{A}. The time dependent Hamiltonian of the whole system 1, in the presence of the annealing field, is given by H(t)=A(t)H_{A}+B(t)H_{f}. H_{f} is the Hamiltonian given by equation (1).

At the start of the annealing process, the system 1 is in an arbitrary state, and A(t=0)=1 and B(t=0)=0. Through the annealing process, the transverse field is reduced such that at the end of the process (at t_{end}), A(t=t_{end})=0, and B(t=t_{end})=1. Through the course of this process, the information qubits 3 are in in a superposition of spin up and spin down states, and gradually relax to the ground state, through quantum tunnelling. The state of the information qubits 3 is then read out. This can be seen as equivalent to cooling, where the field corresponds to the temperature.

States other than the ground state can also be read out, by reading out the state of the ensemble 5 at various stages before B(t=t_{end})=1. In this way, a spectrum of the states near the ground state can be obtained. As discussed below, the spectrum may have a number of uses.

To return the correct states, whether it is the ground state or a higher energy state above the ground state, the ancilla qubits 9 must be in their ground state, where the i^{th} qubit will be up for i>s, and down for i≤s. The energy spectrum will only remain valid while the ancilla qubits 3 remain in the ground state.

If the annealing field results in the energy of the system 1 approaching or exceeding Jₐ, the ancilla qubits 9 may not necessarily be in the ground state, and so spurious states may be create and read out. Therefore, the energy spectrum is only valid where Jₐ is sufficiently large and/or the energy from the annealing field sufficiently small that the ancilla qubits will always be in the ground state. The spurious states can be detected and discarded if necessary.

In some circumstances, Jₐ is sufficiently large and/or the energy from the annealing field sufficiently small such that the spectrum is valid over the whole annealing process. In other circumstances, the spectrum may only be valid for a portion of the process, when the annealing field is reduced. However, if only the ground state of the system 1 is required, then the conditions of equations (7e) and (7f) may be relaxed to:

q₀<minᵢ(f′ᵢ) (7e′)

Jₐ>maxᵢ(f′ᵢ)−q₀ (7f′)

The spectrum produced will be symmetric, because all states having the same number of information qubits 3 in the up state will have the same energy. However, correct selection of the function f enables the relative energies of all states with a given number of information qubits 3 in the up direction can be controlled, so that these states can be differentiated.

As discussed above, an optimisation problem may include a number of terms, each having a number of different variables. The system 1 discussed above is suitable for providing the coupling required for a single term requiring N-local coupling.

For each term requiring N-local coupling (N>2), an additional set of N ancilla qubits 9 is required, forming an additional coupler 7. However, only a single information qubit 3 is required for the variable. For example, for an optimisation problem involving 5 variables (A to E), with a first term involving three variables (A to C), and a second term also involving three variables (C to E), one variable is shared between both terms. The information qubit 3 corresponding to the shared variable is coupled to all other information qubits 3. It is also coupled to a first set of three ancilla qubits 9, which are coupled to information qubits 3 A to C, and a second set of ancilla qubits 9, which are coupled to information qubits 3 C to E.

The cost function of the optimisation problem may also include terms that require 1-local or 2-local coupling. For each term requiring 2-local or 1-local coupling, the additional coupling can be superimposed onto the system 1 by applying additional local fields or biases. In the case of 2-local coupling, the additional field is applied to the coupling link 11 between the corresponding pair of information qubits 3. In the case of 1-local coupling, the additional field is applied directly to the corresponding information qubit 3.

To provide an architecture that is capable of reconfiguration for different problems, a system 1 may be provided with N information qubits 3 and M>N ancilla qubits 9. In one example, a system 1 may be arranged to handle up to m terms (m couplers 7). In this example, the number of ancilla qubits 9 is M=m×N. The system 1 may be capable of full connection, so that it can have up to N-local coupling, but the coupling links may also be controllable, so some of the interactions can be turned off if less than N-local coupling is required.

FIG. 2A schematically illustrates a circuit to implement a system 1 with N information qubits 3, and a single coupler 7 with N ancilla qubits 9, for providing one N-local coupling interaction, as discussed above. FIG. 2B shows a circuit arrangement for the specific example of N=4. The circuits shown in FIGS. 2A and 2B provides a simple means for realising the connectivity shown in FIG. 1.

The circuit uses a first coupling loop 15 which couples all the information qubits 3 and ancilla qubits 9 together, effectively providing pairwise couplings between each possible pairs of qubits 3, 9. As shown in FIG. 1, the pairwise coupling between ancilla qubits 9 is not required. Therefore, a second coupling loop 17 is provided.

The second coupling loop 17 provides a second pairwise coupling between the ancilla qubits 9. The first loop 15 is biased to couple ferromagnetically, while second loop 17 is biased to couple anti-ferromagnetically. Therefore, the pairwise coupling between the ancilla qubits 9 from the first loop 15 is cancelled out by the pairwise coupling between the ancilla qubits 9 from the second loop 17.

The qubits 3, 9 are coupled to the loops 15, 17 through inductors 21. The mutual inductance between the information qubits 3 or the ancilla qubits 9 and the first loop 15 is M. The mutual inductance between the ancilla qubits 9 and the second loop 17 is −M, to ensure that the second loop 17 properly offsets the interactions between the ancilla qubits 9 caused by the first loop 15.

It will be appreciated that the sign of the biasing of the two loops may be swapped.

The strength of the effective 2-local couplings shown in FIG. 1 is J=Jₐ∝M²Σᵢ₌₁^{N}Σ_{j≠i}^{N}σᵢ^{z}σⱼ^{z}30 O(M³), where |M| is the mutual inductance between the qubits 3, 9 and the coupling loops 15, 17. Systems 1 are usually engineered such that O(M³) and higher terms can be neglected, however even in cases where this is not true these higher order terms will affect all of the qubits 3, 9 in a symmetric manner, and therefore can be compensated by a adjusting f′.

In the example shown in FIG. 2B, the information qubits 3 and ancilla qubits 9 are implemented as compound-compound Josephson junction magnetic flux qubits 3, 9.

A compound-compound Josephson qubit has four separate Josephson junctions 19. A first Josephson junction 19a is provided in parallel with a second Josephson junction 19b, to form a first compound junction 23a, or superconducting quantum interference device (SQUID). Similarly, a third Josephson junction 19c is provided in parallel with a fourth Josephson junction 19b, to form a second compound junction 23b or SQUID. The first compound junction 23a and second compound junction 23b are connected in parallel, and connected in an inducting loop 21 formed by a superconducting transmission line.

For the coupling interactions 11, 13 to effectively reproduce an N-local coupler, the information qubits 3 and ancilla qubits 9 must be identical. In practice this may be difficult to achieve due to manufacturing intolerances and the like. However, a correcting field may be applied across the pair of SQUIDs 23 in each qubit 3, 9 to correct for this.

The coupling loops 15, 17 are also formed by a superconducting transmission line. The coupling loops 15, 17 and the inducting loop 21 are formed as single closed loops, with parallel tracks running around the length of the loop.

The loops 15, 17 are arranged so that the strength of the coupling (J=Jₐ) can be controlled using a magnetic field. In the example shown in FIG. 2A, this is achieved by providing a Josephson junction 31a,b in each loop 15, 17. In this example, the strength of the coupling can be controlled by applying a field to the Josephson junction 31a,b.

In the example shown in FIG. 2B, the loops 15, 17 are formed as compound loops, having a pair of Josephson junction 27a,b, provided in parallel (forming SQUIDs) and connected into the loops 15, 17.

By changing the field applied to the SQUID 25a or Josephson junction 31a in the first coupling loop, the sign and magnitude of the inductive coupling between the qubits 3, 9 and the first coupling loop 15 can be changed. By changing the field applied to the SQUID 25b or Josephson junction 31b in the second coupling loop 17, the sign and magnitude of the inductive coupling between the ancilla qubits 9 and the coupling second coupling loop 17 can be controlled. The fields applied to the SQUIDs 25 or Josephson junction 31 can be used to create the required coupling strengths, discussed above.

It is worth noting that the energy of the circuit with a coupling loop 15 coupling N qubits 3, 9 is:

$$\begin{matrix}U = - {E}_{c} cos {∅}_{c} - {\sum }_{i = 1}^{N} {E}_{i} cos {∅}_{i} + \frac{1}{2 {e}^{2}} {( \vec{∅} - \vec{{∅}^{x}} )}^{T} {𝕃}^{- 1} ( \vec{∅} - \vec{{∅}^{x}} ) & ( 9 ) \\ 𝕃 = ( \begin{matrix}{L}_{C} & - {M}_{1 c} & {M}_{2 c} & … \\ - {M}_{1 c} & {L}_{1} & 0 & … \\ {M}_{2 c} & 0 & {L}_{2} & … \\ ⋮ & ⋮ & ⋮ & ⋱\end{matrix} ) & \end{matrix}$$

Where ø_{c} is the phase of the compound junction 25 or Josephson junction 31 on the coupling loop 15, Eᵢ is the energy of each qubit 3, 9 (set as required by the optimisation problem), øᵢ is the phase of each qubit, \vec{ø} is a vector of the junction phases, \vec{ø} is the phase introduce by the external flux applied to the compound junction 25 or Josephson junction 31 on the coupling loop 15, and L is the inductance, with L_{c} the self-inductance of the coupling loop 15, Lᵢ the self-inductance of the i^{th} information qubit 3, and M_{ic} the inductance between the i^{th} qubit 3 and the coupling loop 15.

The phase across the junction is a physical quantity which can be thought of as a quantum analogue of the voltage across a capacitor. It is derived from the U(1) symmetry of quantum mechanics, which is the symmetry which is responsible for all of electromagnetism.

The first two terms of equation (9) are the Josephson potential of the coupler and the N qubits; these depend linearly upon the cosine of the phase difference across the corresponding Josephson junction. The last term is the magnetic energy stored in the device.

The external field is chosen so that:

$$\vec{{∅}^{x}} = ( \begin{matrix}{∅}_{c}^{x} \\ π + ( \frac{{M}_{1 c}}{{L}_{1}} ) ( {∅}_{c}^{( 0 )} - {∅}_{c}^{x} ) \\ π + ( \frac{{M}_{2 c}}{{L}_{2}} ) ( {∅}_{c}^{( 0 )} - {∅}_{c}^{x} ) \\ ⋮\end{matrix} ) \qquad ( 10 )$$

This field ensures the correct coupling between information qubits 3, so that the circuit shown in FIG. 2B replicates the connectivity shown in FIG. 1. The field is chosen so that the energy from flipping the state of a qubit 3 is dependent on the relative orientation of a connected pair of bits. Therefore, there is a first energy when both qubits 3, 9 have the same state, and a second energy when both qubits 3, 9 have different states

By substituting in equation (10), equation (9) can be solved to give:

$$U = C + {∅}_{c}^{x} {\sum }_{i = 1}^{N - 1} {\sum }_{j > 1}^{N} \frac{{M}_{ic} {M}_{jc}}{4 {e}^{2} {L}_{c} {L}_{j}} ( {∅}_{i}^{( 0 )} - π ) ( {∅}_{j}^{( 0 )} - π ) \qquad ( 11 )$$

Where C is a constant. The energy given by Equation (11) shows that for the circuit shown in FIG. 2A or 2B, with the N information qubits 3 coupled to a single coupling loop 15, is equivalent to providing 2-local couplers between each possible pair of information qubits. The energy is tuneable with ø_{c}^{x}, such that the same architecture can be used for different problems.

Equation (11) applies to the coupling of the information qubits 3 or ancilla qubits 9 to the first coupling loop 15 and the ancilla qubits 9 to the second coupling loop 17. The external fields on the loops 15, 17 are chosen so that the biasing on the first loop 15 is in the opposite direction to the biasing on the second loop 17, so the second coupling loop 15 cancels out the coupling between the ancilla qubits 9 created by the first coupling loop 15.

In an alternative example, the second coupling loop 17 may be omitted. Instead, the coupling between the ancilla qubits 9 is compensated for by choosing:

h_{a,i}=Jₐ(N−2i)+qᵢ−J(i²+(N−i)²−2i(n−i)) (12)

This example only requires one coupling loop 15, but the strength of fields on the ancilla qubits 9 scales as N², rather than N as for the case with the second coupling loop.

In use, the optimisation problem is programmed by setting an external field (h) on the information qubits 3, and individual fields (h_{a,i}) on each ancilla qubit. Fields are also applied to the coupling loops 15, 17, to set the strength of the coupling interactions. A further field is also set on all the qubits 3, 9, to correct for any differences in the manufacture of the qubits 3, 9. The annealing field is then set, and gradually reduced. As the annealing field is reduced, the qubits 3, 9 gradually relax, through quantum tunnelling, into the ground state when the field is 0. The state of the information qubits 3 can be read out at any point.

Techniques for reading out the state of the information qubits 3 are known in the art.

Where only 3-local coupling is required, the connectivity can be simplified. The constraints on the N=3 system 1 can be written in 1-, 2- and 3-local terms only. The 3-local term that needs to be reproduced is given by the function f. One example is:

H₃=J₃σ₁^{z}σ₂^{z}σ₃^{z} (13)

As can be seen, for all qubits in the up state, or for any variation of one qubit in the up state, H₃=J₃, for all variations of two qubits in the up state, or no qubits in the up state, H₃=−J₃. Alternatively, the Hamiltonian may be different, and distinguish between the different number of information qubits 3 in the up state, as discussed in relation FIGS. 1, 2A and 2B.

Following on from the example discussed in relation to FIGS. 1, 2A and 2B, the effect of equation (13) can be replicated using a single ancilla qubit 9, coupled as shown in FIG. 3. The 2-local coupling Hamiltonian for this system 1 is:

H₂=J(σ₁^{z}σ₂^{z}+σ₂^{z}σ₃^{z}'0σ₁^{z}σ₃^{z})+h(σ₁^{z}+σ₂^{z}+σ₃^{z})+(Jₐ(σ₁^{z}+σ₂^{z}+σ₃^{z})+hₐ)σₐ^{z} (14)

Where σ_{i=1,2,3}^{z} is the spin state of the information qubits 3, and σₐ^{z} is the spin state for the ancilla qubit 9. As before, h is the uniform field on the information qubits 3, and hₐ is the field on the ancilla qubit 9.

With correct choice of J, h, Jₐ and hₐ (see equations (15a) to (15d)), the spectrum of equation (14) splits into two sections—a high energy section which is ignored, and a low energy section which replicates the spectrum of equation (13).

$$\begin{matrix}{J}_{a} > 0 & ( 15 a ) \\ J = \frac{{J}_{a}}{2} & ( 15 b ) \\ h = \frac{{h}_{a}}{2} = {J}_{3} & ( 15 c ) \\ \vert {J}_{a} \vert ≫ \vert h \vert & ( 15 d )\end{matrix}$$

As seen from equation (15b), the inductive coupling to the ancilla qubit 9 must be twice as strong as the coupling to each of the information qubits 3. This is different to the N>3 cases, where J=Jₐ.

Where the fields and coupling strengths are set so that state of the ancilla qubit 9 is down if a majority of information qubits 3 are up, and the ancilla qubit 9 up otherwise, the low energy part of the spectrum is obtained. The case in which the ancilla qubit 9 agrees with a “majority vote” of the information qubits 3 will provide the high energy part of the spectrum, and will include spurious states.

If Equation (15d) is relaxed to |Jₐ|>|h|, the ground state may still be obtained, but not the full energy spectrum.

FIG. 4 shows an example of a circuit that may be used to implement 3-local coupling with a single ancilla qubit 9.

The ratio of J to Jₐ is fixed by the construction of the circuit, and so is not user tuneable. Therefore, an additional coupling loop 29 is provided, that is coupled to the information qubits 3 only. As discussed in relation to equations (9) to (11), coupling ancilla or information qubits 3, 9 to a single loop 15 forms coupling links 11, 13 of equal strength between all the qubits. However, as shown by equation (15b), in the example with 3 information qubits and a single ancilla qubit 9, the coupling between the information qubits 3 is different to the coupling between the information qubits 3 and the ancilla qubit 9. The additional coupling loop 29 adjusts the strength of the coupling between the information qubits 3, as required.

The additional coupling loop 29 is formed in the same manner as the first coupling loop 15 and the second coupling loop 19.

Instead of the second coupling loop 29, three individual coupling loops could be provided between the information qubits 3, to implement the same constraints.

A person skilled in the art will readily understand how to implement the circuits shown in FIGS. 2A, 2B and 4 on a chip or integrated circuit, along with the necessary connections and components required to apply the desired fields (biases). The person skilled in the art will also appreciate that the system 1 shown in FIGS. 1, 2A and 2B is easily scalable to larger numbers of information qubits 3, such as tens or hundreds of qubits. Alternatively, smaller cells of, for example, N=3 or N=4 can be used as a unit cell, and scaled into a larger architecture.

In the above, terms of O(M³) and higher have been ignored. However, as N increases, terms of the order O(M³) and higher may be significant. These terms add a correction of g_{s→s+1} to equation (5). This can be compensated for by setting the field in each ancilla qubit 9 to be h_{a,s}→h_{a,s}−1/2g_{s→s+1}.

In some examples, additional compound Josephson junctions may be provided near the inductive couplings between the coupling loops 15, 17 and the information qubits 33. Fields applied to the additional compound Josephson junctions can be tuned, to correct for any mismatches between the coupling strengths, so that all junctions have equal coupling strengths. These junctions may be omitted.

Additional junctions are not needed for the ancilla qubits 9, as the effect of any mismatch is small.

In the above examples, the coupling loops 15, 17, 29 are implemented as closed loops with parallel tracks. It will be appreciated that this geometry is given by way of example only. Any suitable geometry may be used to implement the loops instead of closed loop parallel tracks.

In the above examples, Josephson junctions 31 or SQUID 25 are provided in the coupling loops 15, 17, 29 to allow the strength of the coupling to be controlled. It will be appreciated that any suitable means may be used to control the strength of the coupling. Alternatively, in some examples, the ability to control the strength of the coupling may be omitted.

In the above examples, the information qubits 3 and ancilla qubits 9 are inductively coupled to the coupling loops 15, 17, 29. It will be appreciated that any suitable means for coupling the qubits 3, 9 to the loops 15, 17, 29 may be used.

The example circuit shown in FIGS. 2A and 2B can be used for three or more information qubits 3. The circuit shown in FIG. 4 is only suitable for embodiments having exactly three information qubits 3.

It will be appreciated that the circuits shown in FIGS. 2A, 2B and 4 are only examples of how to implement the connectivity shown in FIGS. 1 and 3. Any suitable means may also be used to couple the information qubits 3 to each other and to the ancilla qubits 9. Minor embedding techniques may be used, or separate coupling loops for each required coupling may be used. It will be appreciated that even for low N, the circuit shown in FIGS. 2A, 2B and 4 provide a simple way of implementing the connectivity, and as N increases, these alternative options will become more and more complex, while the implementation shown in FIGS. 2A, 2B and 4 is relatively simple.

In the above example, the qubits 3, 9 have been described as superconducting magnetic flux qubits. It will be appreciated that the techniques discussed above may be implemented in any suitable form of qubit 3, 9. For example, other types of superconducting qubit may be used. Alternatively, the qubits may be realised as single electron transistors, trapped ions, or any other type of qubit 3, 9. It will further be appreciated that the type of fields used to control the qubits 3, 9 and the coupling interactions 11, 13 between the qubits 3, 9 will vary depending on the different type of qubit used 3, 9.

In the example of a magnetic flux qubit 3, 9 magnetic fields are used to control the qubits. The field is applied by using magnetic induction from superconducting control wires (not shown). However, it will be appreciated that any source of magnetic field could be used.

In the above example, the quantum annealer 1 has been described in terms of an optimisation problem. However, it will be appreciated that by stopping or pausing the annealing process before the annealing field is reduced to a minimum, the quantum annealer 1 provides a spectrum of states near the ground state, rather than just the ground state. These states may still be useful. In the example of an optimisation function, the cost difference between the ground state and the near ground states may be minimal, so the near ground states are still useful. Furthermore, this allows the annealing process to be stopped before it is complete, saving processing resources. In addition, having knowledge of the near ground states may be useful for sampling problems, such as machine learning, and other applications.

1. A method of forming coupling interactions between three or more information qubits in a qubit ensemble, the method including:
coupling the information qubits to each other;
coupling each of the information qubits to each of one or more ancilla qubits; and
controlling the interaction between the information qubits by applying a bias to the one or more ancilla qubits, such that the low energy states of the qubit ensemble include three-or-more-body coupling effects between information qubits.

2. The method of claim 1, wherein biasing the ancilla qubits to control the coupling between the information qubits modifies the energy spectrum of the ensemble of information qubits by adding a penalty energy dependent on the state of the information qubits.

3. The method of claim 2, wherein each qubit has two states, and the energy penalty is a symmetric penalty, such that it is dependent on the number of qubits in each state.

4. The method of claim 1, wherein the method is for forming coupling interactions between three information qubits, the method including:
coupling the three information qubits to a single ancilla qubit.

5. The method of claim 4, wherein the strength of the coupling between the ancilla qubit and the information qubits is greater than the strength of the coupling between information qubits.

6. The method of claim 1, wherein coupling each of the information qubits to each of one or more ancilla qubits includes:
coupling the information qubits to an equal number of ancilla qubits.

7. The method of claim 6, wherein each ancilla qubit is only coupled to information qubits, and the coupling between the ancilla qubits and the information qubits is the same strength as the coupling between information qubits.

8. The method of claim 6, wherein coupling the information qubits to an equal number of ancilla qubits includes:
coupling the ancilla qubits to each other and to the information qubits; and
offsetting the coupling between the ancilla qubits
wherein applying a bias to the one or more ancilla qubits includes:
applying a different bias to each ancilla qubit, such that ancilla qubits are ordered based on the applied bias.

9. The method of claim 6, wherein the ancilla qubits are arranged such that when an information qubit flips state, a predetermined ancilla qubit flips states, the predetermined ancilla qubit based on the total number of qubits in each state before and after the information qubit flips state.

10. (canceled)

11. The method of claim 1, wherein controlling the interaction between the information qubits also includes one or more of:
setting the strength of the coupling between the information qubits; setting the strength of the coupling between the information qubits and the ancilla qubits; and applying a uniform bias to the information qubits.

12. The method of claim 1, including:
forming a first interaction between a first set of information qubits of the qubit ensemble by:
coupling the first set of information qubits to each other;
coupling each of the first set of information qubits each of one or more ancilla qubits of a first set of ancilla qubits; and
controlling the interaction between the first set of information qubits by applying a bias to the first set of ancilla qubits; and
forming a second interaction between a second set of information qubits of the qubit ensemble by:
coupling the second set of information qubits to each other;
coupling each of the second set of information qubits to each of one or more ancilla qubits of a second set of ancilla qubits; and
controlling the interaction between the second set of information qubits by applying a bias to the one or more second set of ancilla qubits,
wherein the first set of information qubits and the second set of information qubits share one or more qubits, and the first set of ancilla qubits and the second set of ancilla qubits are separate.

13. (canceled)

14. The method of claim 11, including:
programming an optimisation problem into a quantum annealer including the qubit ensemble by applying biases to the information qubits and the ancilla qubits, and setting the strength of the coupling between the information qubits, and the strength of the coupling between the information qubits and the ancilla qubits; and running a quantum annealing process on the quantum annealer, in order to obtain the state of the qubits in one or more low energy states, the states of the qubits corresponding to solution of the optimisation problem,
wherein the biases and coupling strengths are derived from the optimisation problem, such that interactions are formed between sets of qubits corresponding to variables in terms of the optimisation problem; and
wherein running a quantum annealing process comprises applying an annealing field to the quantum annealer, reducing the annealing field.

15. (canceled)

16. A quantum annealer including:
an ensemble of three or more information qubits;
one or more ancilla qubits;
means for coupling the information qubits to each other;
means for coupling each of the information qubits to each of the one or more ancilla qubits; and
means for applying a bias to the one or more ancilla qubits to control the coupling between the information qubits, such that the low energy states of the qubit ensemble include three-or-more-body coupling effects between the information qubits.

17.-18. (canceled)

19. The quantum annealer of claim 16, including a first coupling loop,
wherein the means for coupling the information qubits to each other comprises means for inductively coupling each information qubit to the coupling loop, with equal strength; and
wherein the means for coupling each of the information qubits to each of the one or more ancilla qubits comprises means for inductively coupling the or each ancilla qubit to the first coupling loop, with equal strength.

20.-22. (canceled)

23. The quantum annealer of claim 19, including an additional coupling loop, wherein only the information qubits are coupled to the additional coupling loop, the additional coupling loop for setting the strength of the coupling between the information qubits.

24.-25. (canceled)

26. The quantum annular of claim 19,
wherein the information qubits are coupled to an equal number of ancilla qubits, and the coupling between the ancilla qubits and the information qubits is the same strength as the coupling between information qubits; wherein each ancilla qubit is only coupled to information qubits; and
wherein the first coupling loop provides coupling interactions between the ancilla qubits, and wherein the quantum annealer includes means for offsetting the coupling between the ancilla qubits.

27. The quantum annealer of claim 26, wherein the means for offsetting the coupling between the ancilla qubits includes an offset loop, and means for inductively coupling the ancilla qubits to the offset loop.

28.-34. (canceled)

35. The quantum annealer of claim 16, wherein:
the information qubits and ancilla qubits are superconducting flux qubits; and
applying a bias to the qubit comprises applying a magnetic field.

36. The quantum annealer of claim 35, including a first coupling loop, and wherein the means for coupling the information qubits to each other comprises means for inductively coupling each information qubit to the coupling loop, with equal strength,
wherein the first coupling loop is a loop formed by a superconducting wire or transmission line.

37. The quantum annealer of claim 27,
wherein the information qubits and ancilla qubits are superconducting flux qubits;
wherein applying a bias to the qubit comprises applying a magnetic field; and
wherein the offset loop is formed by a superconducting wire or transmission line.
